(19) United States
(12) Patent Application Publication
(10) Pub. No.: US 2004/0088575 A1
(43) Pub. Date: May 6, 2004

(54) Secure remote network access system and method

(76) Inventors: Allen J. Piepho, Windsor, CO (US); Gregory J. Lipinski, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/285,770

(22) Filed: Nov. 1, 2002

(51) Int. Cl. H04L 9/00

(52) U.S. Cl. 713/201

(57) ABSTRACT

An embodiment of a secure remote network access method comprises monitoring a state of a first storage medium using a shared access point operable to enable a process to read data on the first storage medium. The method also comprises, when a threshold has been reached, selecting at least one file resident on the first storage medium, and transferring the at least one file to a second storage medium.

### TECHNICAL FIELD OF THE INVENTION

The present invention relates generally to the field of computer systems and, more particularly, to a secure remote network access system and method.

### BACKGROUND OF THE INVENTION

The explosive growth of global communication networks such as the Internet has increased users' ability to quickly and effectively communicate a variety of content from site to site, including transferring files. For example, users may use electronic mail, e.g., email, documents, and images, and hyperlinks that point to content on a particular website.

Unfortunately, such convenience has a price. In many instances, security may be breached in a variety of methods by unauthorized users. For example, a user connected to the Internet using a digital subscriber line (DSL) is susceptible to an unauthorized break-in by, for example, hackers at a remote location. This security breach may result in damage to computer files and/or installation of rogue applications. These break-ins increasingly occur, transparent to a user, while files are being transferred to or from a computer over the Internet. Rogue applications may then be used to harm the location where they are resident, or other locations, by and for example, deleting files, or scheduling denial-of-service attacks via the Internet. Moreover, unauthorized users may also access and/or alter files that have been included for a variety of reasons, e.g., copyright.

### SUMMARY OF THE INVENTION

An embodiment of a secure remote network access method comprises monitoring a state of a first storage medium using a shared access point operable to enable a process to read data on the first storage medium. The method also comprises, when a threshold has been reached, selecting at least one file resident on the first storage medium, and transferring the at least one file to a second storage medium.

An embodiment of a secure remote network access system comprises a first storage medium and application logic. The application logic is operable to access the first storage medium through a shared access point and to monitor a state of the first storage medium. When a threshold has been reached, the select logic is operable to select at least one file resident on the first storage medium and transfer the at least one file to a second storage medium.

Another embodiment of a secure remote network access method comprises validating at least one file resident on a first storage medium using a shared access point operable to enable a process to read and write data on a second storage medium. The method also includes, if the at least one file is valid, transferring the at least one file to the second storage medium.

Another embodiment of a secure remote network access system comprises a first storage medium and application logic operable to access the first storage medium through a shared access point operable to enable the application logic to read and write data on the first storage medium. The application logic is also operable to validate at least one file resident on a second storage medium using the shared access point. The application logic is also operable to, if the at least one file is valid, transfer the at least one file to the first storage medium.

Yet another embodiment of a secure remote network access method comprises monitoring a state of a first storage medium in an appliance using a shared access point. The shared access point is operable to enable a process to read and write data on the first storage medium. The method further comprises selecting at least one file resident on the first storage medium, and transferring the at least one file to a second storage medium.

### BRIEF DESCRIPTION OF THE DRAWINGS

For a more complete understanding of the present invention and the advantages thereof, reference is now made to the following descriptions taken in connection with the accompanying drawings and which:

FIG. 1 is a block diagram, of an embodiment of a secure remote access system utilizing teachings of the present of the present invention;

FIG. 2 is an example of a method that may be used in a secure remote access system utilizing teachings of the present invention; and

FIG. 3 is an example of another method that may be used in a secure remote access system utilizing teachings of the present invention.

### DETAILED DESCRIPTION OF THE DRAWINGS

From the foregoing, it may be appreciated that a need has arisen for providing a method for securely and remotely accessing system over a network. In accordance with the present invention, a secure remote network access system and method are provided that substantially reduce or eliminate the disadvantages with conventional systems and methods.

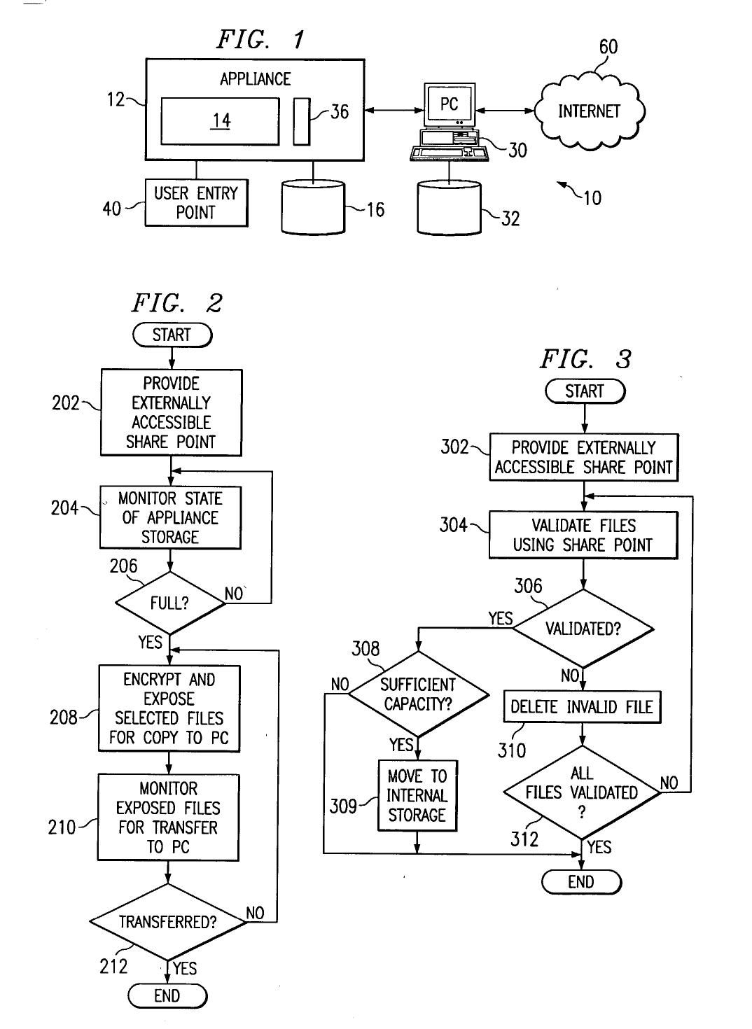

FIG. 1 is a block diagram of an embodiment of a secure remote network access system utilizing teachings of the present invention. Secure remote network access system 10 includes an appliance 12 and a personal computer (PC) 30. Appliance 12 is operable to import and export files through PC 30 using a shared access point 36. System 10 reduces breaches in security according to the teachings of the present invention. For example, system 10 enables files to be imported and exported into appliance 12 by minimizing breaches in security that may be caused by unauthorized users. The present invention contemplates using a secure access point 36 to monitor and control importation and exportation of files to appliance 12 through another network element such as PC 30. PC 30 represents any processing platform operable to access and to be accessed by appliance 12 and to transfer files or other data to or from appliance 12. Importing and exporting files using such a method reduces the exposure of files to access by others over the network. Embodiments of the present invention reduce or eliminate the possibility of damage to computer files and/or installation of rogue applications, as well as the harm that would otherwise be caused at a variety of locations by, for example, rogue applications scheduling denial-of-service attacks via the Internet. Moreover, the present invention contemplates a method and system for importing and exporting files that reduces the possibility that unauthorized users could alter and/or violate copyright protection of certain data on the system, thereby improving the ability to effectively manage digital rights of data. Some examples of digital rights include the rights to publish, to transfer, and to copy data under copyright laws of various jurisdictions, including the United States.

Appliance 12 may also be any processing platform. For example, PC 30 and/or appliance 12 may be general or specific-purpose computers or a portion of a computer adapted to execute an operating system. Appliance 12 and/or PC 30 may also be wireless devices such as cell phones or personal digital assistants. In a particular embodiment, appliance 12 may be a network appliance such as a digital entertainment center, and is operable to process a plurality of media types, including music, “books on tape,” lectures, etc. To illustrate, if appliance 12 is a digital entertainment center, a consumer-user may perform functions such as, for example, automatically tracking and digitally recording selected music files, and to pause, rewind and instantly replay music programs much like a video cassette recorder (VCR) records and plays back video cassettes. Appliance 12 may be one of a variety of appliances now known or developed in the future. For example, appliance 12 may be an appliance substantially similar to a VCR whose dedicated function is to enable a user to, for example, play, rewind and record video cassettes. Appliance 12 and PC 30 may use the same or different operating systems (OSs).

To further illustrate, a network appliance such as a digital entertainment center includes a single user entry point or interface 40, and is operable to process a plurality of media types, including music, “books on tape,” lectures, etc. Thus, if appliance 12 is a digital entertainment center, a user entry point 40 enables a consumer-user to perform functions such as, for example, automatically tracking and digitally recording selected music files, and to pause, rewind and instantly replay music programs much like a VCR records and plays back video cassettes. A user entry point 40 may be a GUI with functions such as those described above, or such as those presented with a word processing program such as Word, available from Microsoft Corporation. A user entry point 40 does not enable the consumer-user to access, change, or move files, beyond the extent permitted by the dedicated functions in user entry point 40. Appliance 12 may be one of a variety of appliances now known or developed in the future. For example, appliance 12 may be an appliance substantially similar to a VCR whose dedicated function is to enable a user to, for example, play, rewind and record video cassettes. The invention contemplates the development of new technologies that encompass today's traditional household appliances such as, but not limited to, ranges, refrigerators, televisions, and others, whether or not they include a substantial amount of electronic circuitry or logic, such as a stereo. These appliances may be operated by a user through a user entry point 40.

The invention contemplates the development of new technologies that encompass today's traditional household appliances such as, but not limited to, ranges, refrigerators, televisions, and others, whether or not they include a substantial amount of electronic circuitry or logic, such as a stereo. Moreover, the invention contemplates a number of appliances that may be Internet-enabled; that is, these appliances may send and receive information over a network such as, but not limited to, the Internet, through one of many types of communication links. These communication links may be, for example, a dedicated line, such as a digital subscriber line (DSL) or a cable modem line. For example, appliance 12 may also be directly or indirectly coupled to a network such as Internet 60 using a variety of methods, such as a network interface card (NIC). For example, a NIC may include one or more communication functions such as a dial-up modem, Ethernet modem, and/or a modem that conforms with the Home Phoneline Network Alliance (HOMEPNA) using widely varying bandwidths. The present invention contemplates a variety of other representative configurations for appliance 12, PC 30, and network 20 now known or that may be developed in the future.

Appliance 12 also includes a shared access point 36 as an isolated storage medium or partition in either of PC 30 or appliance 12. For example, shared access point 36 may be a mount point that enables monitoring, access, and transfer of files between PC 30 and appliance 12. For example and not by limitation, shared access point 36 may be configured in accordance with the Server Message Block (SMB) protocol (a SMB mount point), Network File System (NFS) or other protocols that provide a suitable access point. The Network File System (NFS) was developed to enable machines to mount a disk partition on a remote machine as if it were on a local hard drive, for fast, seamless sharing of files across network(s). SMB is known by the name Common Internet Filesystem (CIFS), and is a client-server, request-response protocol that enables sharing of files, printers, serial ports and other communications abstractions, such as named pipes and mail slots, between processing elements such as computers. In a particular embodiment, a client such as PC 30 may connect to a server such as appliance 12 using TCP/IP, NetBEUI, or other suitable transport protocols. After establishing a connection, a client PC 30 may send commands to server appliance 12 that enable the two elements to access shares, open files, read and write files, and perform other file system functions over network 20. Using this example, shared access point 36 may be a selected directory that is accessible by PC 30, and configured as desired using the OS of appliance 12. For example, access may be granted as read-write to PC 30, with the use of a selected password. Shared access point 36 may also be a standalone storage device or remotely-located device accessible to network 20.

Appliance 12 includes one or more applications 14 that may be software, firmware or hardware and that are used to monitor the importation and exportation of files to appliance 12. Applications 14 may be, in a particular embodiment, programs or software routines or processes that may be executed by any processor. These programs or routines may be supported by a memory system (not explicitly shown), such as a cache or random access memory (RAM) suitable for storing all or a portion of these programs or routines and/or any other data during various processes performed by these applications. The software code or routines may be implemented using a variety methods including, but not limited to, object-oriented methods, and using a variety of languages and protocols. Applications 14 may also be hardware or other logic that may include general circuitry or special-purpose digital circuitry which may be, for example, application-specific integrated circuitry (ASIC), state machines, fuzzy logic. In other embodiments, these applications may include software or firmware that includes procedures or functions and, in some embodiments, may be user-programmable as desired, depending on the implementation. In a particular embodiment, application 14 may be a daemon logic or process invoked as desired to monitor appliance storage medium 16, PC storage medium 32, and/or both using a method, such as the ones discussed in further detail in conjunction with FIGS. 2 and 3, in accordance with the teachings of the present invention.

FIGS. 2 and 3 are examples of methods that may be used in a secure remote access system utilizing teachings of the present invention. Generally, the methods comprise providing a shared access point so that files may be exported from, or imported to, an appliance while maximizing digital rights management and minimizing security risks by minimizing any exposure of files to external network access. The terms ‘exporting’ and ‘importing’ include the processes of transferring files between locations. These transfers contemplate copying, archiving, sharing, checking out files, and other methods for transferring files now known or hereinafter developed. Various embodiments may utilize fewer or more steps, and these methods may be performed using a number of different implementations, depending on the application.

FIG. 2 is an example of a method that may be used in a secure remote access system utilizing teachings of the present invention. In step 202, shared access point 36 is provided at a point in network 20. For example, shared access point 36 may reside in isolated storage medium or partition in either of PC 30, appliance 12, as a standalone storage device, or a remotely located device accessible to network 20. In step 204, application 14 monitors the state of appliance storage medium 16. If appliance storage medium 16 is not in a selected state, such as not ‘full’ in step 206, the method continues to monitor the state of appliance storage in step 204.

This description utilizes the term ‘full’ for illustration, and not limiting, purposes. As but an example, in step 206, any selected state may be utilized, or alternatively, a threshold or flag may be utilized. For example, a flag indicating a percentage of capacity, number of files currently stored, or other suitable statistic may be used while a system monitors the state of appliance storage medium 16. This state may then be used to determine whether to continue to the next step, where the method proceeds to encrypt selected files and expose these files for transfer to PC 30 in step 208. Similarly, these files may be selected according to any desired implementation. For example, they may be selected according to priority, age or other indicators as needed.

If, on the other hand, appliance storage medium 16 is determined to be ‘full’ in step 206, the method proceeds to step 208, where selected files are preferably encrypted and exposed on shared access point 36 for transfer to PC 30. Encryption, among other things, may reduce the possibility of piracy or alteration of these files during their exposure to others on shared access point 36. In step 210, these exposed files are monitored. If the files have not been transferred at the time of monitoring in step 212, the method continues to expose the selected files for transfer to PC 30 in step 208. If, on the other hand, the monitoring in step 210 indicates that the files have been transferred in step 212, the method ends.

The method illustrated above, as an example, assumes that, once the exposed files have been transferred to PC 30 in step 212, the files have been successfully transferred. Other embodiments of the method may include monitoring activity through the shared access point to determine whether the exposed files have been accessed or read by others. Such an embodiment may be effective in monitoring whether digital rights of the at least one file have been compromised. Thus, these same files may be deleted from appliance storage medium 16, if they have been transferred and are no longer desired. Other actions, such as, but not limited to, compressing these files or transferring them to another platform accessible to network 20 may be desirable, depending on the application.

FIG. 3 is an example of another method that may be used in a secure remote access system utilizing teachings of the present invention. In step 302, shared access point 36 is provided at a point in network 20. For example, shared access point 36 may reside in isolated storage medium or partition in either of PC 30, appliance 12, as a standalone storage device, or a remotely located device accessible to network 20. In step 304, application 14 monitors and performs validation checks for files in PC 30 from appliance 12 using shared access point 36. If a file is valid in step 306, the method continues to step 308, where, in a particular embodiment, the method may inquire whether appliance 12 has storage capacity for the validated files to be transferred. If so, in step 309 the method transfers the valid file to appliance storage medium 16 from PC 30, and then the method ends.

In step 306, any validation procedure may be utilized. For example, a file type or size indicating a file's creation date, author, or whether the file is an executable program may be used while monitoring these files on PC 30. This state may then be used to determine whether the method proceeds to validate these files for transfer to appliance 12 in step 308. In this manner, some control may be exerted over which files to transfer, thus reducing the risk of transferring harmful code such as a virus, trojan horse, or other rogue program.

If, on the other hand, a file is found to be not valid in step 306, the method proceeds to step 310, where the invalid file is deleted from PC 30. The method then continues to step 312. If in step 312 all of the files have not been validated, the method proceeds to step 304 where it continues to validate the next file for transfer from PC 30 to appliance 12. If in step 312, on the other hand, all files have been validated, the method ends.

A variety of other methods utilizing teachings of the present invention may be used in addition to those discussed in conjunction with FIGS. 2 and 3. For example, in step 204, application 14 may monitor other activities or states rather than the state of appliance storage medium 16. For example, step 204 may be used to monitor the age of selected files so that they may be archived on another platform such as PC 30 in storage such as PC storage 32. In such a scenario, method 206 might query, for example, whether selected files are beyond a certain age limit.

What is claimed is:

1. A secure remote network access method, comprising:
monitoring a state of a first storage medium using a shared access point operable to enable a process to read data on the first storage medium;
when a threshold has been reached, selecting at least one file resident on the first storage medium; and
transferring the at least one file to a second storage medium.

2. The method of claim 1, further comprising configuring the shared access point in accordance with one of the group consisting of a set of protocol standards known by the names Secure Message Block (SMB), Common Internet File System (CIFS), and Network File System (NFS).

3. The method of claim 1, further comprising monitoring whether the at least one file has been transferred to the second storage medium.

4. The method of claim 1, further comprising encrypting the at least one file.

5. The method of claim 1, further comprising monitoring whether digital rights of the at least one file have been compromised.

6. The method of claim 1, further comprising deleting the at least one file from the first storage medium once the at least one file has been transferred to the second storage medium.

7. The method of claim 1, further comprising associating the first storage medium with an appliance.

8. The method of claim 1, further comprising monitoring the state of the first storage medium by monitoring whether the storage medium is full.

9. A secure remote network access system, comprising:
a first storage medium;
application logic operable to access the first storage medium through a shared access point and to:
monitor a state of the first storage medium;
when a threshold has been reached, select at least one file resident on the first storage medium; and
transfer the at least one file to a second storage medium.

10. The system of claim 9, wherein the shared access point is configured in accordance with one of the group consisting of a set of protocol standards known by the names Secure Message Block (SMB), Common Internet File System (CIFS), and Network File System (NFS).

11. The system of claim 9, wherein the logic is further operable to encrypt the at least one file.

12. The system of claim 9, wherein the logic is further operable to monitor whether the at least one file has been transferred to the second storage medium.

13. The system of claim 9, wherein the logic is further operable to delete the at least one file from the first storage medium if the at least one file has been transferred to the second storage medium.

14. The system of claim 9, wherein the first storage medium is associated with an appliance.

15. The system of claim 9, wherein the logic is further operable to monitor the state of the first storage medium by monitoring whether the storage medium is full.

16. A secure remote network access method, comprising:
validating at least one file resident on a first storage medium using a shared access point operable to enable a process to read and write data on a second storage medium; and
if the at least one file is valid, transferring the at least one file to the second storage medium.

17. The method of claim 16, further comprising:
determining whether the second storage medium has sufficient capacity; and
if the at least one file is valid and the second storage medium has sufficient capacity, transferring the at least one file to the second storage medium.

18. The method of claim 16, further comprising configuring the shared access point in accordance with one of the group consisting of a set of protocol standards known by the names Secure Message Block (SMB), Common Internet File System (CIFS), and Network File System (NFS).

19. The method of claim 16, further comprising validating the at least one file based on content type.

20. The method of claim 16, further comprising encrypting the at least one file.

21. The method of claim 16, further comprising monitoring whether digital rights of the at least one file have been compromised.

22. The method of claim 16, further comprising automatically deleting the at least one file if the at least one file is an executable file or if the at least one file is not valid.

23. The method of claim 16, further comprising associating the second storage medium with an appliance.

24. A secure remote network access system, comprising:
a first storage medium; and
application logic operable to access the first storage medium through a shared access point operable to enable the application logic to read and write data on the first storage medium and to:
validate at least one file resident on a second storage medium using the shared access point, and
if the at least one file is valid, transfer the at least one file to the first storage medium.

25. The system of claim 24, wherein the logic is further operable to:
determine whether the second storage medium has sufficient capacity; and
if the at least one file is valid and the second storage medium has sufficient capacity, transfer the at least one file to the first storage medium.

26. The system of claim 24, wherein the shared access point is configured in accordance with one of the group consisting of a set of protocol standards known by the names Secure Message Block (SMB), Common Internet File System (CIFS), and Network File System (NFS).

27. The system of claim 24, wherein the logic is further operable to encrypt the at least one file.

28. The system of claim 24, wherein the logic is further operable to validate the at least one file based on content type.

29. The system of claim 24, wherein the logic is further operable to automatically delete the at least one file if the at least one file is an executable file or if the at least one file is not valid.

30. The system of claim 24, wherein the first storage medium is associated with an appliance.

31. A secure remote network access method, comprising;
monitoring a state of a first storage medium in an appliance using a shared access point operable to enable a process to read data on the first storage medium;
selecting at least one file resident on a second storage medium; and
transferring the at least one file to the first storage medium.

32. The method of claim 31, wherein the shared access point is configured in accordance with a set of protocol standards known by the name Secure Message Block (SMB).

33. The method of claim 31, further comprising monitoring whether the at least one file has been transferred to the second storage medium.

34. The method of claim 31, further comprising encrypting the at least one file.

35. The method of claim 31, further comprising validating the at least one file before transferring the at least one file.

36. The method of claim 31, further comprising monitoring whether digital rights of the at least one file have been compromised.

37. The method of claim 31, further comprising causing deletion of the at least one file from the first storage medium once the at least one file has been transferred to the second storage medium.

38. The method of claim 31, further comprising associating the second storage medium with an import computer.
